(19) United States
(12) Patent Application Publication
(10) Pub. No.: US 2005/0158425 A1
(43) Pub. Date: Jul. 21, 2005

(54) Thin mouthfeel calcium-fortified beverage containing calcium lactate gluconate citrate

(75) Inventors: Simone Johanna Bouman, Almkerk (NL); Liane Rebecca Stefanie Morsink, Groningen (NL); Diderik Reinder Kremer, Groningen (NL); Marcus Johannus Anthonius Wilhelmus Vorage, Balloo (NL); Catharina Houdijk, Rotterdam (NL)

Correspondence Address: OLIFF & BERRIDGE, PLC, P.O. BOX 19928, ALEXANDRIA, VA, 22320, US

(73) Assignee: PURAC BIOCHEM BV, Gorichem (NL)

(21) Appl. No.: 11/003,385

(22) Filed: Dec. 6, 2004

Related U.S. Application Data
(60) Provisional application No. 60/526,590, filed on Dec. 4, 2003.

(51) Int. Cl. A23K 1/175

(52) U.S. Cl. 426/74

(57) ABSTRACT

The present invention relates to a thin mouthfeel, calcium-fortified, beverage to be used to provide dietary calcium supplementation. Said thin mouthfeel calcium-fortified beverage has been calcium-fortified by means of a calcium (lactate) gluconate citrate. It has been found that calcium (lactate) gluconate citrate has a high dissolution rate, a very good taste and sufficient solubility for use in thin mouthfeel beverages. It even performs well as a calcium source in calcium-fortified waters and enhanced (near) water beverages in which the taste requirements are even more demanding than in normal soft drinks. The invention is also directed to calcium-fortified water and enhanced (near) water beverage comprising calcium (lactate) gluconate citrate.

The present invention relates to a thin mouthfeel, calcium-fortified, beverage to be used to provide dietary calcium supplementation.

Osteoporosis, a degenerative bone disease, is recognized as a major public health problem in many countries. It is the most common skeletal disease in the world and results in a significant burden to the population in terms of quality of life and medical expense.

Dietary calcium deficiency has been determined by medical authorities to be an important risk factor for osteoporosis. Calcium is the basic building block of bone, and the need for calcium in our daily diet has been extensively documented in medical and scientific journals. In addition, many government and public health agencies have recommended that individuals strive to include optimal amounts of calcium in their diet to reduce risk for osteoporosis.

Calcium is an essential nutrient needed throughout life, for a number of important physiologic functions. It is reported that ninety-nine percent of the body's calcium is present in teeth and bones. Therefore, calcium is needed for both formation and maintenance of bones and teeth. The remaining one percent of calcium is located throughout the body in the blood and soft tissues and is ionized in part. In its ionized form, calcium is of great importance for blood coagulation, proper functioning of the heart, nerves, and muscles, and in the permeability of membranes. Current scientific research shows evidence that calcium plays a role in protecting against high blood pressure and colon cancer. If there are inadequate amounts of calcium from dietary sources, skeletal calcium will be sacrificed to satisfy the metabolic needs of the soft tissues. Thus, when dietary calcium intake is inadequate, skeletal metabolism is compromised. Under this circumstance, less bone is accumulated during growth and calcium is withdrawn from the adult skeleton with a concomitant reduction of bone strength. Both of these situations appear to predispose a person to osteoporosis and its consequent fractures.

One of the major sources of available calcium for dietary purposes are dairy products. Since fluid milk provides about 300 milligrams calcium per 240 milliliter (8 ounce) serving, the consumption of approximately 6/7 of a liter of milk would be necessary to provide the present minimum recommended amounts of calcium (based on the USA recommended daily allowance (R.D.A)). As this amount of milk can be overbearing, it has been proposed to enrich the milk with a source of dietary calcium to reduce the amount of fluid intake needed to achieve a specific level of calcium supplement. However, many of the very people who need the calcium do not like the taste of milk. A calcium-enriched milk is not the answer for those people. Further, due to lactose intolerance, milk may not be a practical source of calcium for some. people.

Those who cannot tolerate milk or do not like milk can increase their calcium intake by the use of tablets or capsules of calcium salts such as calcium carbonate. However, since the consumption of beverages other than milk, such as soft drinks, is common in everyday life, it would be desirable to develop a calcium-fortified beverage which can be consumed as soft drinks, particularly by people who cannot tolerate or dislike milk.

A number of popular beverages are thin mouthfeel beverages such as clear juices, juice-containing drinks, soft drinks, sports drinks, (near) water beverages and waters. Especially, so-called (near) water beverages have become very popular.

One object of the present invention is to provide a calcium-fortified thin mouthfeel beverage.

Unfortunately, the development of calcium-fortified beverages has met with numerous technical obstacles. In particular, previous attempts at producing calcium fortified fluids, have resulted in products that have low calcium concentrations, suspension settlement issues, require exceptionally long processing times, have unacceptable off flavors that are described as bitter, metallic, chalky, and “minerally”, poor textures or a combination of these drawbacks. For example, insoluble calcium salts need to be added to products as a suspension, but this often leads to negative changes in taste and texture as well as suspension settlement. In addition, insoluble calcium sources are generally less bioavailable than soluble forms. Although some inorganic salts of calcium, such as calcium salts of bicarbonate, chloride, sulfate and some phosphates, possess a solubility which allows relatively high levels of calcium to be added to beverages, they produce unacceptable off tastes. While attempts have been made to cover up the off flavors or poor textures of previous calcium fortified beverages, such efforts have required the addition of materials such as sugars, artificial sweeteners, and flavorings. This results in the addition of calories and/or other (off) flavors.

The requirements with respect to solubility and taste for thin mouthfeel beverages, and more particularly (near) water beverages, are more demanding than for, for instance, nectars, dairy juice and breakfast drinks, because in thin mouthfeel beverages the off taste. is less masked by other ingredients and any sedimentation in thin mouthfeel beverages is more apparent.

Numerous calcium supplements are presently available on the market. Calcium carbonate, calcium lactate, calcium gluconate and calcium citrate anhydrate are commonly used. Calcium carbonate has 40 percent calcium and is generally available in tablet form. As this calcium salt is insoluble, it is not suitable for use in thin mouthfeel beverages for the reasons mentioned-above. Calcium lactate has 13 percent calcium and calcium gluconate has 9 percent calcium. These relatively well soluble calcium salts however, may leave a bitter taste when used in beverages which make them less suitable for use in thin mouthfeel beverages and virtually unsuitable for use in waters. Calcium citrate anhydrate has a very low solubility and thus, is not suitable for use in thin mouthfeel beverages.

In U.S. 2003/0185941 is directed to a non-dairy formulation based on organic rice protein concentrate as the sole source of protein for toddlers and small children. A ready-to-feed beverage described herein comprises 1.5 to about 4.5 mgs organic rice protein per 100 kcal beverage (e.g. 4100 grams per batch), 5.5 to about 15 mgs organic brown rice syrup per 100 kcal of beverage (e.g. 17500 grams per batch) and 0.1 to 0.5 grams per 100 kcal of a calcium source such as for instance calcium lactate gluconate.

In WO 00/28838 a clear, pectine-free fruit-based beverage is described which has been calcium-fortified with calcium gluconate lactate with a gluconate/lactate ratio of 80/20. Said calcium gluconate lactate has a good taste, has high dissolution rate and good solubility. However, this compound is relatively expensive and has a high hygroscopicity at increased temperatures, which may detrimentally affect its storageability.

In WO 00/18258 calcium fortified beverages are described wherein various calcium sources such as calcium hydroxide or calcium carbonate are added in combination with various food acids such as malic acid and citric acid. In some of the embodiments citric acid, malic acid and calcium hydroxide are co-precipitated and dried.

In short, there remains a need for thin mouthfeel calcium-fortified beverages that, effectively and efficiently deliver calcium without delivering nonessential materials that may detract from the consumer's overall health, and that can be readily produced and stored until use. In addition, since beverages that taste bad will not be used, there remains a need for calcium-fortified beverages that have acceptable hedonic properties. Calcium fortified thin mouthfeel beverages are especially valuable as it may be stored at room temperature, consumed in large quantities without contributing “empty calories” and can serve as a fluid calcium source for those who cannot consume milk due to lactose intolerance.

With the present invention a calcium-fortified thin mouthfeel beverage is provided with a good taste, optimal solubility and dissolution rate.

To this end, the present invention is directed to a thin mouthfeel calcium-fortified beverage characterized in that the beverage is calcium-fortified by means of a calcium (lactate) gluconate citrate.

Within the concept of the present invention, the term “thin mouthfeel” means giving a thin and low-viscous sensory experience during consumption. The beverage according to the invention may have a color and some solid particulates such as natural pulp or clouding agent which simulates pulp as long as the ready-to-drink beverage is has a thin mouthfeel. Examples of thin mouthfeel beverages are clear beverages such as clear juice and juice-containing drinks (having a juice content of less that 100%), clear soft drinks, (near) water beverages, waters and clear sports drinks; opalescent beverages such as opalescent juices, opalescent juice-containing drinks, opalescent soft drinks, and opalescent sports drinks. Within the context of the present description clear means substantially transparent, with or without color, with or without some solid particulates as long as the ready-to-drink beverage remains substantially transparent. Examples of clear juices are apple juice, cranberry juice and grape juice. Within the context of the present description opalescent means substantially transparent, but not 100% clear. Examples of opalescent juices are grapefruit juice and pine apple juice.

Calcium gluconate citrate and calcium lactate gluconate citrate salts are known from WO 03/031635. These types of salts may be prepared according to Example 6 of this patent publication, which has been incorporated by reference in this specification for all purposes. The use of these calcium salts in thin mouthfeel beverages has not been disclosed in said publication, nor has its good taste in thin mouthfeel beverages been acknowledged herein. These types of double and triple salts appear to have suprising physical and organoleptic properties. For instance, the solubility of calcium gluconate citrate is totally different from the solubilities of calcium gluconate and calcium citrate, respectively. Further, the taste of calcium gluconate citrate in beverages also differs completely from the taste of calcium gluconate and calcium citrate in beverages when added in the same amounts to the beverage. In the present invention it is essential that the double or triple salt contains both gluconate and citrate, in order to reach the solubility and taste demands.

It has been found that calcium (lactate) gluconate citrate has a high dissolution rate, a very good taste and sufficient solubility for use in thin mouthfeel beverages. It even performs well as a calcium source in calcium-fortified waters and enhanced (near) water beverages in which the taste requirements are even more demanding than in normal soft drinks. The invention is also directed to calcium-fortified water and enhanced (near) water beverage comprising calcium (lactate) gluconate citrate.

Enhanced near water beverages and enhanced water (beverages) provide extra health benefits beyond hydration while they are fortified with minerals, vitamins, electrolytes or other healthy ingredients. When water is enhanced by means of a calcium salt, it is usually referred to as calcium-fortified water. As used herein, the term water includes, but is not limited to, any potable water such as spring water, sterilized water, filtered water, reverse osmosis water, distilled water, carbonated or sparkling water, purified water, artesian water, ground water, mineral water, well water, municipal water, and mixtures thereof. Said water may or may not have a calcium concentration prior to being calcium fortified. Normally, a calcium-fortified water or enhanced water beverage does not contain any flavors and/or sweeteners.

A calcium-fortified near water beverage or enhanced near water beverage is defined as a calcium-fortified water or an enhanced near water beverage, respectively containing small amounts of flavors, sugar and/or sweetners, and/or acidulants In general these amounts of flavors, sugar and/or sweeteners and/or acidulants are lower than in conventional soft drinks.

It was further found that the calcium lactate gluconate citrate has a very low hygroscopicity at increased temperatures. This increases the possibility to store the calcium salt before its use.

The pH of the thin mouthfeel beverage according to the invention is dictated by the tartness in the flavor desired, the desired shelf life and color stability. When desired the pH can be adjusted by means of food-grade acids and/or bases. With respect to shelf life, generally pH's within the range of from about 3 to about 4 are desirable. Any food grade acid can be utilized to adjust the pH of the beverage. For example, phosphoric acid, fumaric acid, citric acid, lactic adipic, lactic acid, gluconic acid and malic acid can be used without developing off taste. Hydrochloric acid is less preferred as the chlorine ion can be nutritionally disadvantageous. The ratio of acids is such as to provide the desired pH level without developing an off taste. Preferably, the acids used for acidification are citric acid and phosphoric acid.

It has further been found that maltodextrin with a dextrose equivalent of from about 10 to about 20, also known as a glucose polymer, has been found to assist in stabilizing the calcium compounds in the acid beverages. It is also known that maltodextrin is an agent that assists in increasing calcium absorption in the body. In an embodiment of the present invention, maltodextrin is included in an amount of ranging from about 1 up to about 40 percent, based on the solids content in the beverage.

The thin mouthfeel beverage of the present invention may be flavored and sweetened to improve its organoleptic acceptability. Known natural sweetening agents such as corn syrup solids, glucose, fructose, sucrose and the like, as well as artificial sweeteners such as saccharin, cyclamates and aspartame can be added in amounts sufficient to provide a sweet flavor. Natural and artificial flavors including fruit and cola flavors can also be added. The thin mouthfeel beverage of the present invention can also include fruit juice or fruit juice extract, preferably without suspended particulates such as citrus fruits and/or cranberry juice as desired. Natural or artificial coloring can be added as desired. As mentioned-above, in the case of (near) water beverages the addition of other ingredients is restricted.

The thin mouthfeel beverages of the invention can also include other ingredients normally found in soft drinks such as clouding agents, preservatives and the like. The provision of the thin mouthfeel beverage allows for the controlled clouding and also coloring of the beverage as long as the mouthfeel of the total beverage remains thin. Dairy products such as whey protein can be added as clouding agents to simulate natural pulp. The beverages can also contain protein for protein fortification though protein may be disadvantageous for calcium absorption, vitamins and minerals as well as agents, which contribute to calcium absorption. It was found that, in contrast to other conventional calcium salts, the calcium (lactate) gluconate citrate causes less denaturalization of the proteins. Preferably, the additives do not incorporate additional particulates in the beverage. Preferably, fully soluble materials such as protein hydrolysates can be used.

Trace amounts of magnesium and zinc salts may contribute to absorption. These types of mineral cations and other nutrient mineral cations may also be added to the thin mouthfeel beverage according to the invention in the form of a soluble salt. In a preferred embodiment such additional nutrient mineral cations are added as part of the counter-cations of the calcium (lactate) gluconate citrate. For the preparation of these types of calcium (lactate) gluconate citrates reference may be had to WO 03/031635.

The beverages can also be carbonated to provide organoleptic characteristics similar to known soft drinks according to known techniques.

The beverages of the present invention can also be prepared in an isotonic formulation to assist in the osmotic absorption of the fluid and the salts. These formulations may suitably be used for, for instance, sports drinks. The amount of sugar and salts are adjusted to provide the desired osmotic pressure. The amount of sugar can be decreased and the flavoring accentuated by synthetic sweeteners.

The beverages according to the invention may be in the form of a ready-to-drink beverage (also called single-strength beverage), but also in the form of a syrup, concentrate or powdered drink, which upon addition of water result in a single strength beverage.

The thin mouthfeel beverage according to the invention will generally comprise more than 3% of the Recommended Daily Allowance (RDA) of calcium, preferably from about 10% to about 100% RDA, most preferably from about 10% to about 40% of the RDA, per unit portion of the beverage. The term “per unit portion of the beverage” should be interpreted so that in the case that the thin mouthfeel beverage is a syrup, concentrate or powdered beverage, the calcium amount will be adjusted so that the resulting single-strength beverage will have a calcium amount falling within the above-mentioned range.

Preferably, the calcium-fortified thin mouthfeel beverages of the present invention are microbially stable. The processing methods used to achieve microbial stability will depend on the particular calcium salts and organic acids used. Treatment of the water with ozone can be inadequate to achieve microbial stability depending on the composition of the product. For example, the presence of malic acid was found to rapidly degrade ozone. Thus, ozonation is inappropriate as a sole method for achieving microbial stability in all compositions. Thermal processing can be used with more highly thermodynamically stable compositions but can cause less stable compositions to precipitate. Chemical preservatives generally have little activity above neutral pH, but can be used to help achieve micro stability at acidic and neutral pH. Other composition dependent methods that can be used to achieve microbial stability of the calcium fortified thin mouthfeel beverages of the present invention include: microfiltration, irradiation, ultraviolet light, high intensity pulsed electric fields, pressure, carbonation, sonication, and combinations thereof. Preferred methods for achieving microbial stability are ozonation, microfiltration, ultraviolet light, carbonation, thermal processing and mixtures thereof.

The calcium gluconate/calcium citrate weight ratio in the single strength beverage may vary from 1:2 to 4:1, preferably 1:2 to 3:1, more preferably 1:2 to 2:1 and most preferably 1:2 to 1:5. The calcium lactate/(calcium gluconate+calcium citrate) ratio may vary from 0:1 to 2:1. Thus, the calcium source of the beverage according to the invention does not necessarily contain lactate. It may contain all variations between pure calcium gluconate citrate and the triple salt of calcium lactate gluconate citrate, in which the weight ratio of calcium lactate/(calcium citrate+calcium gluconate) preferably varies from 0:1 to 2:1. Also combinations of the various calcium (lactate) gluconate citrate salts may be used.

A proposed procedure for preparing the calcium-fortified thin mouthfeel beverages of the invention includes the steps of dissolving the calcium (lactate) gluconate citrate with the other ingredients in part of the water in order to prepare a pre-slurry. After dissolving or mixing, the rest of the water is added to the mixture or vice versa. Alternatively, the calcium (lactate) gluconate citrate is added directly to the water, optionally together with all the ingredients. The order and time of addition of the ingredients depend on the process parameters and type of the ingredients. Part or all of the water may be replaced by juice. Optionally, the resulting solution or dispersion is heated to a temperature between 25 and 100° C. After solubilization, adjustments may be made to the flavor, color, Brix-level, pH and/or volume by adding flavors, colors, acidulants and/or water. The beverage bottled and pasteurized according to good manufacturing techniques.

The compositions of the invention can also be prepared as a syrup, concentrate or powdered beverage which can be later dissolved in water, carbonated water, juice and mixtures thereof, and bottled. The syrup preferably contains sufficient calcium and acidity such that only dissolution is required. Alternatively, pH adjustment, coloring and flavoring can be accomplished at the time of dissolution.

The present invention is more fully explained by means of the Examples below, which are to be considered as illustrative only and not to be construed as limitative.

### EXAMPLE 1

The hygroscopicities of powdered samples of calcium lactate gluconate citrate (in a ratio calcium lactate:calcium gluconate:calcium citrate of 12.7:47.8:39.5) and calcium lactate gluconate (lactate/gluconate ratio 20/80) were measured at 20° C. at 60% relative humidity and at 35° C. at 70% relative humidity. At 20° C. at 60% relative humidity both samples hardly pick up any water (about 1%) for 21 days. At 35° C. at 70% relative humidity however, the calcium lactate gluconate (20/80) sample appears to be completely liquefied within 2 days and had become a hard tablet. The calcium lactate gluconate citrate sample still had the powdered structure and appeared unchanged after 20 days.

### EXAMPLE 2

The dissolution rates of calcium lactate gluconate (ratio Ca lactate:Ca gluconate 80/20) and calcium lactate gluconate citrate (in a ratio calcium lactate:calcium gluconate:calcium citrate of 12.7:47.8:39.5) beverages were determined by measuring the conductivity and calculating the dissolution rate from the conductivity indices. Said beverages contained 10, and 30% R.D.I respectively in water at 20° C., 30% in apple juice at 20° C. and 10% in cranberry juice at 20° C. The results are compiled in TABLE I.

TABLE I
Dissolution time in seconds (at conductivity 99.5)

| | | Apple | Cranberry |
|---|---|---|---|
| | Water | juice | juice |
| | (10% RDI) | (30% RDI) | (10% RDI) |
| Calcium lactate | 35 | 25 | 34 |
| gluconate | | | |
| Calcium lactate | 23 | 30 | 27 |
| gluconate citrate | | | |

These results show that the dissolution rate of the calcium lactate gluconate citrate according to the invention is comparable with the dissolution rate of calcium lactate gluconate.

### EXAMPLE 3

Comparative taste tests were done by a test panel on mineral water containing 10% RDI calcium/serving and on apple juice containing 30% RDI calcium/serving by. comparing to a blank. In mineral water no difference in taste between the calcium lactate gluconate-containing sample (ratio Ca lactate:Ca gluconate 80/20) and calcium lactate gluconate citrate-containing sample (ratio of examples 1 and 2) was observed, whereas in apple juice the calcium lactate gluconate citrate-containing sample was considered better in taste.

### EXAMPLE 4

Three triangle tests were done on mineral water/calcium lactate gluconate citrate (ratio of examples 1 and 2) in mineral water/calcium gluconate citrate (ratio Ca gluconate:Ca citrate 2:1) systems with test panels containing 19 and 12 persons, respectively.

TABLE 2 shows the results. None of the tests showed significant difference between mineral water, calcium lactate gluconate-containing mineral water and calcium gluconate citrate containing-mineral water. However the persons who had the tests right, gave the same comments, these are written down in TABLE 2. So it seems there is a small difference, however only a few people notice it.

1. A calcium-fortified thin mouthfeel beverage characterized in that the beverage is calcium-fortified by means of calcium (lactate) gluconate citrate.

2. A calcium-fortified thin mouthfeel beverage according to claim 1 wherein the beverage is calcium-fortified by means of calcium lactate gluconate citrate.

3. The calcium-fortified thin mouthfeel beverage according to claim 1, wherein the beverage is calcium-fortified by means of calcium gluconate citrate.

4. The calcium-fortified thin mouthfeel beverage according to claim 1, characterized in that the beverage comprises more than 3% of the Recommended Daily Allowance (RDA) of calcium, preferably from about 10% to about 100% RDA, most preferably from about 10% to about 40% of the RDA, per unit portion of the beverage.

5. The calcium-fortified thin mouthfeel beverage according to claim 1, characterized in that said beverage is carbonated.

6. The calcium-fortified thin mouthfeel beverage according to claim 1, characterized in that the beverage is a (near) water beverage.

7. The calcium-fortified thin mouthfeel beverage according to claim 1, characterized in that the beverage further includes additional nutrient mineral cations.

8. The calcium-fortified thin mouthfeel beverage according to claim 1, characterized in that the beverage is an enhanced (near) water beverage.

9. The calcium-fortified thin mouthfeel beverage according to claim 1, characterized in that the beverage further includes maltodextrin to assist in increasing calcium absorption in the body.

10. The calcium-fortified thin mouthfeel beverage according to claim 7, wherein the additional nutrient mineral cations are added as part of the counter-cations of the calcium (lactate) gluconate citrate.

11. The calcium-fortified thin mouthfeel beverage according to claim 1, wherein the beverage is in the form of single-strength beverage, a syrup, concentrate or powdered drink, which upon addition of water result in a single strength beverage.

12. A method for preparing a substantially thin mouthfeel, storage stable, palatable, flavored beverage which does not develop an after taste containing calcium (lactate) gluconate citrate as a source of calcium comprising combining calcium (lactate) gluconate citrate with optionally other ingredients in water to form a pre-slurry, and after dissolution or mixing combining the resulting mixture with water to form a single strength beverage, concentrate or a syrup.

13. The method according to claim 12 wherein (part of the) water is replaced by juice.
